(19) United States
(12) Patent Application Publication
(10) Pub. No.: US 2006/0280534 A1
(43) Pub. Date: Dec. 14, 2006

(54) Apparatus for and method of creating a duplex scan using a single pass ADF

(75) Inventors: Brian D. Cook, Nicholasville, KY (US); Gregory P. Washnock, Lexington, KY (US); Gregory T. Webb, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/152,487

(22) Filed: Jun. 14, 2005

(51) Int. Cl. G03G 15/00

(52) U.S. Cl. 399/374

(57) ABSTRACT

A duplexing auto-document feeder for an all-in-one device having an input tray for stacking a plurality of sheets in feeding communication with a unidirectional feedpath including a simplex path and a duplex path. An image sensor is aligned with first and second platens along the unidirectional feedpath and a selectively actuatable gate is disposed downstream of the input tray directing each of the plurality of sheets through one of a simplex or duplex scanning path. An image sensor is in optical communication with the first and second platens and the simplex and duplex paths.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to scanners and scanning methods, and more particularly to a method of creating a duplex scan using a single pass auto-document feeder (ADF).

2. Description of the Related Art

All-in-one machines typically perform functions such as printing, scanning, copying, and faxing in either a stand alone fashion or in conjunction with a personal computer and define a growing market for peripheral devices. These devices eliminate clutter in a business or home office by combining the desirable functionality of various machines into a single unit, while maintaining an affordable cost. Various all-in-one machines currently in the marketplace use thermal inkjet technology as a means for printing received fax documents, original documents, and copied or scanned images or text. Thermal inkjet printing devices utilize consumable inkjet cartridges in fluid communication with a printhead to record text and images on a print media. The printhead typically moves on a carriage relative to the media path and a control system activates the printhead to selectively eject ink droplets onto the print media.

Scanners are used to scan a target image and create scanned image data which can be displayed on a computer monitor, which can be used by a computer program, which can be printed, which can be faxed, etc. Scanned data may be saved to memory or a magnetic or optical drive, or other fixed or removable memory device. Scanning devices may be packaged in a stand-alone housing or as part of the all-in-one device, as described herein, including a printing module to perform scanning as well as standard copying functions.

Scanners typically include a housing aperture defined by an edge wherein a platen is located. A target document is positioned on the platen for scanning of the text or image by a scanbar. Depending on the positioning of the scanbar relative to the platen, the platen may be transparent where the scanbar is beneath the platen or may be solid where the scanbar is above the platen. For a typical flatbed scanner, the scanbar will be below the platen, which will have a transparent section to allow for the scan operation.

The scanner may also include an auto-document feeder (ADF) to automatically and sequentially feed a plurality of documents to a scan module. The auto-document feeder typically comprises a feed tray and an input device which feeds a single sheet from the stack of media on the feed tray into the auto-document feeder media path. The single sheet of media passes the reading position where the media is illuminated and image data is created representing images on the media. The media then passes from the auto-document feeder to a stacking tray where the media remains until all of the media from the feed tray has been scanned and is removed from the stacking tray at the output side of the auto-document feeder.

Generally most auto-document feeders are single-side imaging devices. To scan a double-sided image, the media must be turned which is often done manually. Prior art patents have taught various means for reversing media sides and performing double-sided or duplex scanning. According to one method of duplex scanning, the scanning module comprises first and second image sensors to scan first and second sides of the media. However, the problem with these devices is that the two image sensors require large amounts of space and therefore make the equipment footprint much larger. This is not suitable for many applications, such as home, office equipment or small office equipment. Further, the use of two image sensors increases the costs of the device which is also undesirable.

A second method of performing duplex scanning is to utilize a switchback path and reversible motor which requires the media to pass a reading position. Next the media moves through a switchback path or loop in order to orient the second side of the media toward the image sensor for a second pass wherein the duplex scan is performed. However, reversing a page within a media path causes increased incidents of paper jams and is therefore undesirable. Further, such motion typically requires a subsequent collation step to correctly orient the media in the stacking or output tray.

Given the foregoing deficiencies, it will be appreciated that an improved method and apparatus for creating a duplex scan is needed.

### SUMMARY OF THE INVENTION

According to a first embodiment, the present invention comprises a duplexing auto-document feeder for an all-in-one device having an input tray for stacking a plurality of sheets in feeding communication with a unidirectional feedpath, the unidirectional feedpath including a simplex portion and a duplex portion. An image sensor is aligned with first and second platens along the unidirectional feedpath and a gate is disposed downstream of the input tray directing each of the plurality of sheets through one of a simplex or duplex scanning path. The simplex path passes one of the first and second platens and the duplex path passes both of the first and second platens. The image sensor acquires one side of the scan data through both of the first and second platens.

The gate is selectively engageable between a simplex position and a duplex position. The simplex path is substantially C-shaped. The duplexing path includes at least one substantially S-shaped portion. Specifically, the duplexing path has a first S-shaped portion and a second reverse S-shaped portion. The duplexing path is substantially enclosed by the simplex path.

The image sensor is in optical communication with the upper and lower platens. The auto-document feeder performs duplex scanning without requiring reversal of rollers disposed in the unidirectional feedpath to change direction of media in the feedpath. The unidirectional feedpath is a single pass continuous feedpath.

According to a second embodiment, a duplexing auto-document feeder for a scanner comprises an input tray in communication with a unidirectional feedpath, the unidirectional feedpath has a simplex portion and a duplex portion, a gate is selectively actuatable to allow feeding communication between the input tray and one of the simplex portion and the duplex portion. An image sensor has a scanning position in optical communication with the unidirectional feedpath. A simplex platen on the simplex path is in optical communication with the image sensor. A duplex platen on the duplex path is in optical communication with the image sensor. One of the simplex platen and the duplex platen is disposed between the image sensor and the other of the simplex platen and the duplex platen. The duplex portion has a curvilinear path defined by a first S-shaped path and a second reverse S-shaped path. The duplexing platen is disposed between the first S-shaped path and said second reverse S-shaped path. The simplex portion partially surrounds the duplex portion. Alternatively, the duplex path may be a substantially linear path defined by a plurality of angled linear paths.

According to a third embodiment a duplexing auto-document feeder for a scanner comprises an auto-document feeder having a unidirectional feedpath, a gate selectively engageable between a first simplex position and a second duplex position, a simplex platen and a duplex platen aligned between an image sensor and the unidirectional feedpath. Each of the simplex and duplex platens are in optical communication with the image sensor. The feedpath has a length between the first platen and the second platen greater than a media length. The simplex platen and the duplex platen are at least partially aligned with an image sensor.

According to a fourth embodiment, a method of duplex scanning comprises selecting one of a simplex or duplex scan, activating a gate corresponding to the selecting of the simplex or duplex path, calibrating an image sensor based on the selecting of the simplex and duplex scan, directing a sheet in a single direction from an input tray through either a duplex feedpath or a simplex path having shared path portion with the duplex path, moving the sheet to a first platen and a second platen when the duplex feedpath is selected, the first and second platens in optical communication with an image sensor, moving the sheet over one of the first platen and the second platen when the simplex feedpath is selected.

An improved method and apparatus for creating a duplex scan having a single media feed direction which decreases paper jams caused by media reversing and switchback loops as taught by prior art devices. The apparatus maximizes use of volume of the duplexing ADF and saves time by allowing selection of simplex or duplex scanning.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an all-in-one device with single pass duplexing auto-document feeder;

FIG. 2 is a perspective view of the single pass auto-document feeder of FIG. 1 with cover set removed;

FIG. 3 is a perspective view of FIG. 2 with a side frame removed;

FIG. 4 is a side view of the single pass duplexing auto-document feeder;

FIG. 5 is a side view of FIG. 4 with media disposed in the simplex media path;

FIG. 6 is a side view of FIG. 4 with media disposed in the duplex media path;

FIG. 7 is a flowchart depicting the method of duplex scanning of the present invention; and,

FIG. 8 is a side view of a first alternative media path design.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The term image as used herein encompasses any printed or digital form of text, graphic, or combination thereof. The term output as used herein encompasses output from any printing device such as color and black-and-white copiers, color and black-and-white printers, and so-called “all-in-one devices” that incorporate multiple functions such as scanning, copying, and printing capabilities in one device. Such printing devices may utilize ink jet, dot matrix, dye sublimation, laser, and any other suitable print formats. The term button as used herein means any component, whether a physical component or graphic user interface icon, that is engaged to initiate output. The terms unidirectional and single pass as used herein means that the media only passes any position in the feedpath a single time during a media feeding step and are therefore interchangeable.

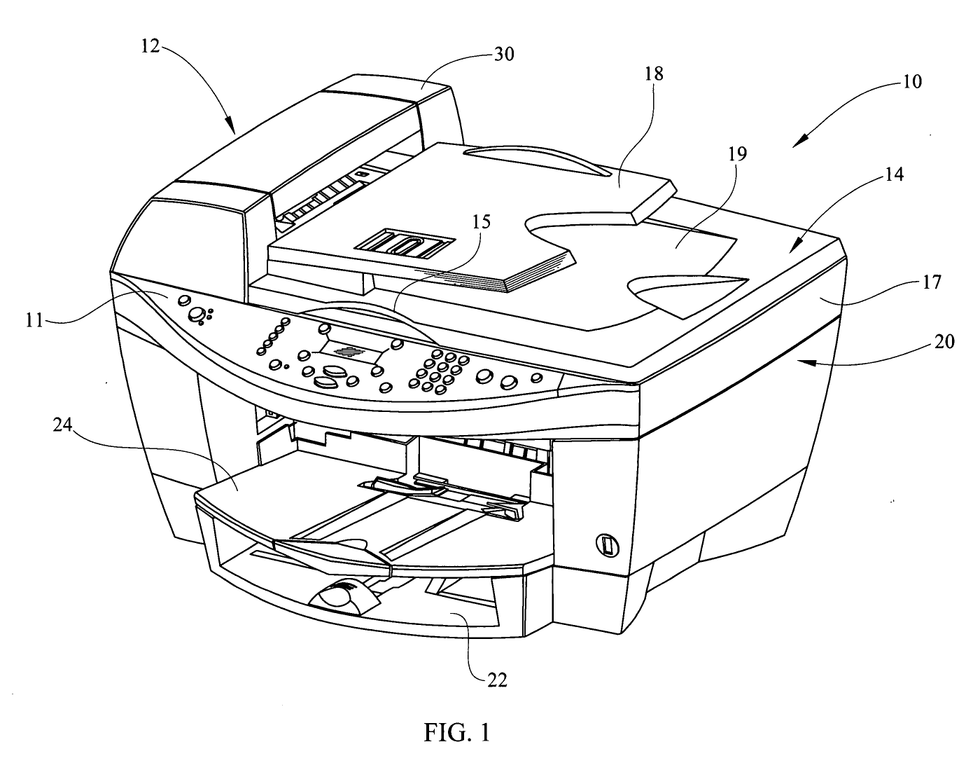

Referring now in detail to the drawings, wherein like numerals indicate like elements throughout the several views, there are shown in FIGS. 1-8 various aspects of an apparatus for and method of creating a duplex scan using a single pass auto-document feeder. The apparatus provides various functions including minimizing cost and size of the auto-document feeder while increasing media throughput and reliability, i.e., fewer document handling related jams. According to a first function, the apparatus directs media through a scanning station area without requiring feedback handling or reversal of the media in the feedpath. According to a second function, the apparatus collates the scanned pages while eliminating the need for a distinct collating step as required by prior art auto-document feeder device. According to a third function, the apparatus provides a continuous feedpath which does not overlap or intersect at any location where the media would be moving in opposite directions.

Referring initially to FIG. 1, an all-in-one device 10 is shown having an scanner portion 12 and a printer portion, generally defined by and located within a housing 20. The all-in-one device 10 is shown and described herein, however one of ordinary skill in the art will understand upon reading of the instant specification that the present invention may be utilized with a stand alone printer, copier, auto-document feed scanner, or other device utilizing a media feed system. The peripheral device 10 further comprises a control panel 11 having a plurality of buttons for making selections. The control panel 11 may also include a graphics display to provide a user with menus, selections or errors occurring with the device 10.

Still referring to FIG. 1, extending from the printer portion 20 is an input tray 22 and an exit tray 24 disposed above the input tray 22. The printer portion 20 may include various types of printing mechanisms including, but not limited to, a laser printing mechanism or an ink-jet printing mechanism. These are known in the prior art and therefore will not be described herein.

Referring still to FIG. 1, the scanner portion 12 generally includes an auto-document feeder 30, a scanner bed 17 and a lid 14, which is hingedly connected to the scanner bed 17. Beneath the lid 14 and within the scanner bed 17 may be a transparent platen for placement and support of target media or original documents for manually scanning. Along a front edge of the lid 14 is a handle 15 for opening of the lid 14 and placement of the target document on the transparent platen (not shown). Adjacent the lid 14 is an exemplary duplexing auto-document feeder or ADF 30 which automatically feeds and scans stacks of documents which are normally sized, e.g., letter or A4, and suited for automatic feeding. Above the lid 14 and adjacent an opening in the auto-document feeder 30 is an auto-document feeder input tray 18 which supports a stack of target media or documents for feeding through the auto-document feeder 30. Beneath the input tray 18, the upper surface of the lid 14 also defines an output tray 19 for receiving documents fed through the auto-document feeder 30 and scanned by the scanner 12.

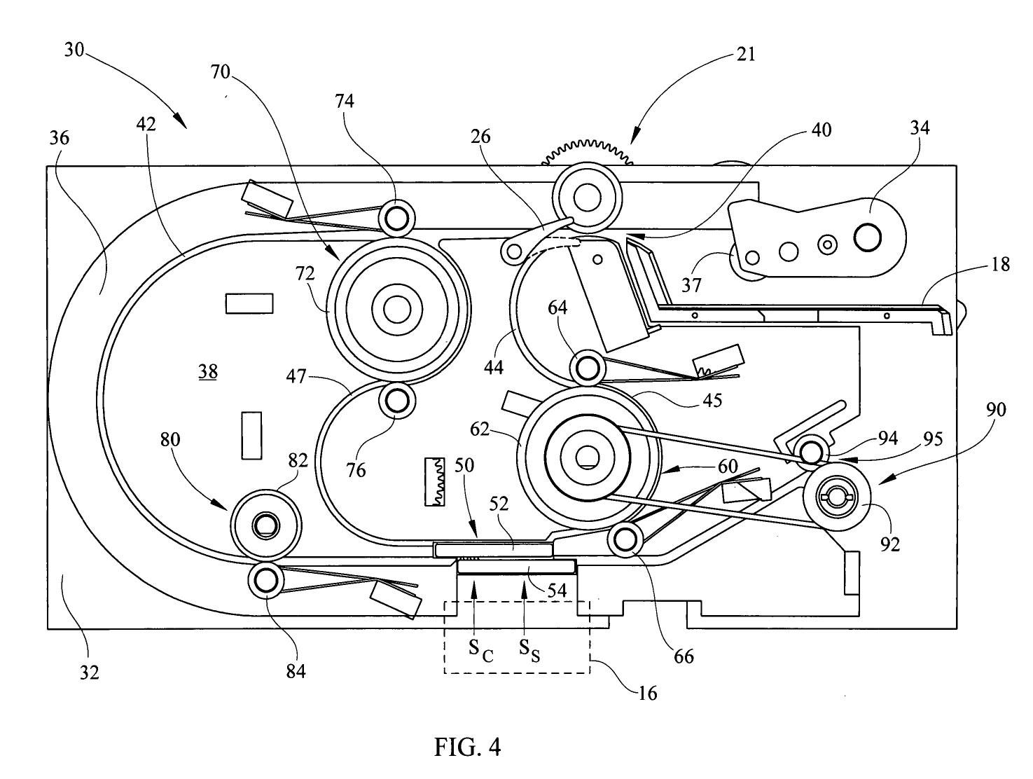

Beneath the auto-document feeder 30 is an optical scanning unit having a plurality of parts which are not shown but are generally described herein. The scanning unit may comprise a scanning motor and drive connecting the scanning motor and a scan bar 16, shown generally in FIG. 4. The scan bar 16 is driven bi-directionally along a scanning axis defined as the direction of the longer dimension of a scanner bed. At least one guide bar may be disposed within the scanner bed 17 and may extend in the direction of the scanning axis to guide the scanning bar 16 along the scanning axis. The scan bar 16 moves along the at least one guide bar within the scanner bed beneath the platen. The scan bar 16 has a length which extends in the shorter dimension of the scanning bed. Thus, the scan bar 16 extends across one dimension of the scanner bed and moves in a perpendicular dimension to scan an entire surface area of the platen during flatbed scanning. The scan bar 16 is disposed in either of three positions: Sₛ for simplex or duplex scanning and S_{c} for duplex calibration. A third position (not shown) provides a location for simplex calibration and is generally located near a flatbed scanning home position.

The scan bar 16 may include a lamp, an image sensor, and a mirror therein for obtaining a scanned image from a document. The image sensor may be an optical reduction type image sensor or a contact image senor (CIS) as is known in the art. In either event, the image sensor then determines the image and sends data representing the image to onboard memory, a network drive, or a PC or server housing, a hard disk drive or an optical disk drive such as a CD-R, CD-RW, or DVD-R/RW. Alternatively, the original document may be scanned by the optical scanning component and a copy printed from the printer portion 20 in the case of a multi-function peripheral device 10. The scan bar 16 is generally either an optical reduction type using a combination of lens, mirror and a CCD (Charge Coupled Device) array or CIS (Contact Image Sensors) array. The CCD array is a collection of tiny, light-sensitive diodes, which convert photons into electrons. These diodes are called photosites—the brighter the light that hits a single photosite, the greater the electrical charge that will accumulate at that site. The image of the document that is scanned using a light source such as a fluorescent bulb reaches the CCD array through a series of mirrors, filters and lenses. The exact configuration of these components will depend on the model of scanner. Some optical reduction scanners use a three pass scanning method. Each pass uses a different color filter (red, green or blue) between the lens and CCD array. After the three passes are completed, the scanner software assembles the three filtered images into a single full-color image. Most optical reduction scanners use the single pass method. The lens splits the image into three smaller versions of the original. Each smaller version passes through a color filter (either red, green or blue) onto a discrete section of the CCD array. The scanner software combines the data from the three parts of the CCD array into a single full-color image. The CCD array has a longer focal length than a contact image sensor (CIS) and therefore may be preferable for use in the instant invention.

In general, for inexpensive flatbed scanners contact image sensors (CIS) are used in the scan bar. CIS arrays replaces the CCD array, mirrors, filters, lamp and lens with an array of red, green and blue light emitting diodes (LEDs) and a corresponding array of phototransistors. The image sensor array consisting of 600, 1200, 2400 or 4800 LEDs and phototransistors per inch (depending on resolution) spans the width of the scan area and is placed very close to the glass plate upon which rest the image to be scanned. Another version of the CIS used a single set of red, green and blue LEDS in combination with light pipes to provide illumination of the material to be scanned. When the image is scanned, the LEDs combine to provide a white light source. The illuminated image is then captured by the row of sensors. CIS scanners are cheaper, lighter and thinner, but may not provide the same level of quality and resolution found in most optical reduction scanners. Color scanning is done by illuminating each color type of LED separately and then combining the three scans.

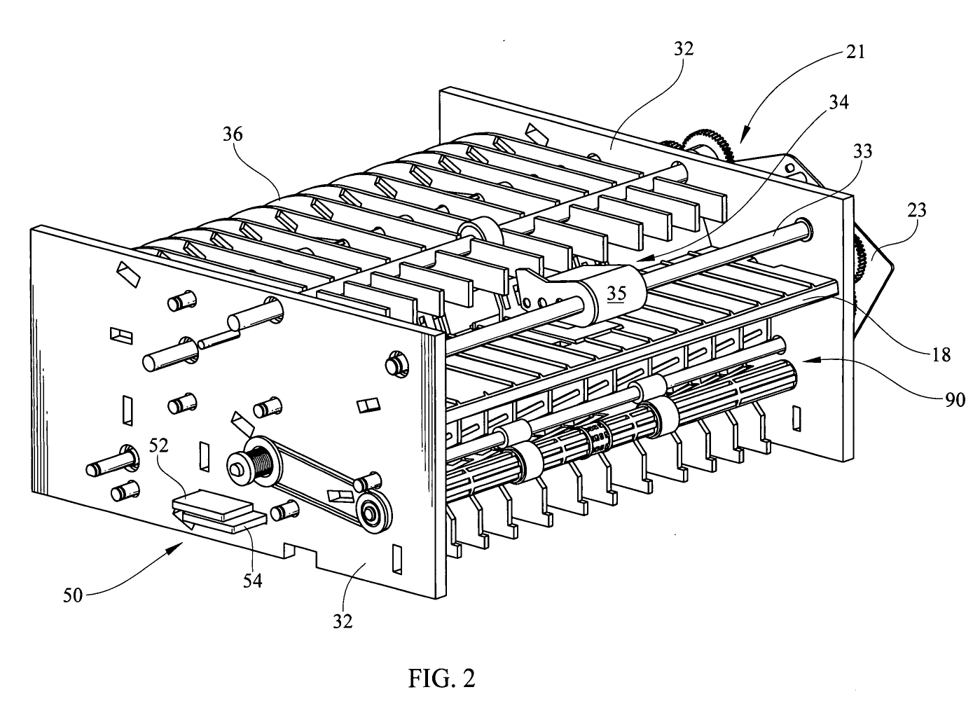

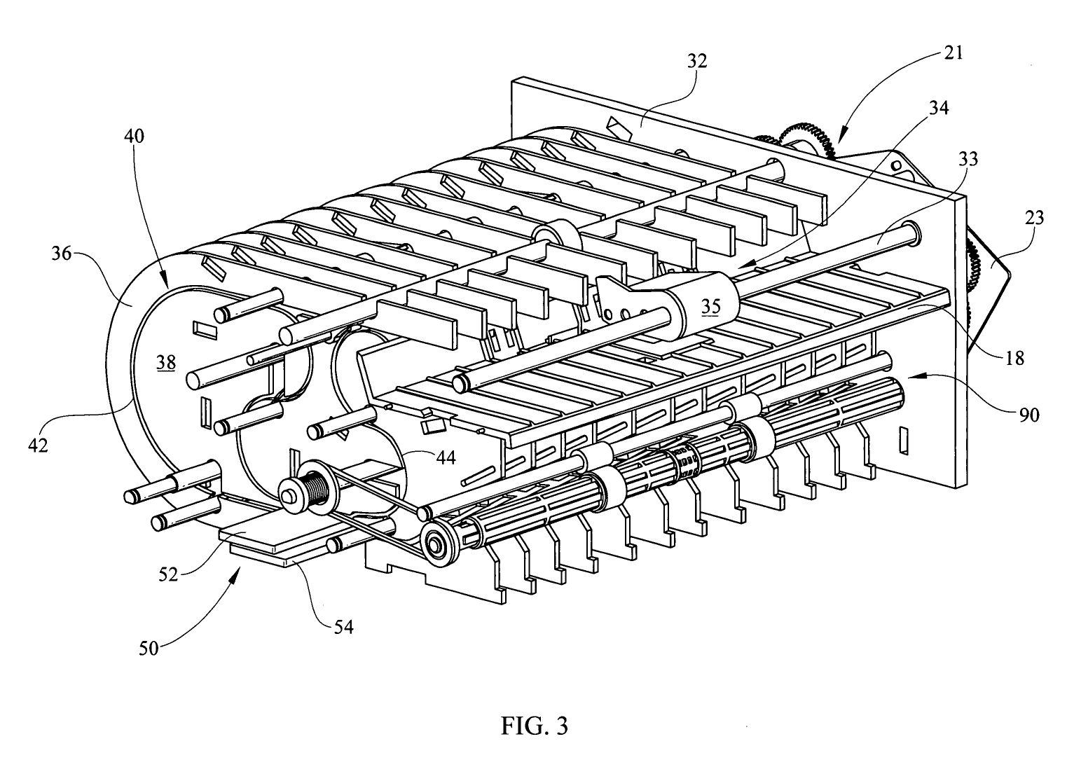

Referring now to FIGS. 2-3, a perspective view of the internal components defining the single pass duplexing auto-document feeder 30 is shown with the cover set removed. Two opposed side frames 32 form ends of the ADF 30. The side frames 32 of the auto-document feeder 30 provide a structure for locating shafts and rollers of the duplexing auto-document feeder 30. The side frames 32 also allow rotation of the various shafts and rollers. A gear train 21 is also shown mounted to one side frame 32, causing rotation of the shafts and rollers extending between the side frames 32. The gear train 21 is driven by a motor (not shown) which is mounted to a motor plate 23.

The duplexing auto-document feeder 30 further comprises an outer frame portion 36 and an inner frame portion 38 which partially define the unidirectional auto-document feeder feedpath 40. The outer frame 36 is substantially C-shaped and extends over the input tray 18 near the pick mechanism 34. The outer frame 36 is comprised of a plurality of interconnected parallel ribs spaced apart and extending around the inner frame 38 from the input tray 18 to the exit system 90. According to an alternative embodiment an inner portion of the auto-document feeder cover set may form the outer frame 36. The inner frame 38 is also defined by a plurality of inter-connected parallel ribs which define a duplexing path 44. The inner frame portion 38 is substantially surrounded by the outer frame portion 36 defining a media feedpath 40 therebetween. The shafts extending between the side frames 32 extend through the inner and outer frames 36,38.

Referring now to FIG. 4, a side view of the duplexing auto-document feeder 30 is depicted. The auto-document feeder 30 comprises a pick system 34, a scanning station 50, a duplexing feed system 60, a delivery system 70, a feed system 80, and an exit system 90.

Above the ADF input tray 18 is the pick mechanism 34 which picks an uppermost media sheet from a media stack on the ADF input tray 18 and feeds the media sheet into the ADF 30. Subsequent sheets from the media stack are fed sequentially, one sheet at a time, into the auto-document feeder 30. The pick mechanism 34 comprises a shaft 33 rotatably suspended between the side frames 32. The pick mechanism 34 further comprises an auto-compensating mechanism 35 which includes an internal gear train (not shown) and a pick tire 37 (FIG. 4). The auto-compensating mechanism 35 is known to one of ordinary skill in the art and therefore will not be described in detail. Further, it is well within the scope of the instant specification that alternative pick mechanisms may be utilized.

The ADF input tray 18 defines a starting point for the feedpath 40 within the single-pass auto-document feeder 30. The media feedpath 40 generally extends from the input tray 18 to the exit tray 19 and includes a simplex path 42 and a duplex path 44. Specifically, a simplex path 42 is substantially C-shaped and extends between the inner frame 38 and the outer frame 36 from a gate 26 (FIG. 4) to the exit system 90. Within the inner frame 38 is the duplex path 44 which is substantially curvilinear and described further herein.

The duplex path 44 begins near input tray 18 and receives media from the adjacent the pick system 34. The duplex path 44 comprises two substantially S-shaped paths. Specifically, the duplex path 44 is defined by a first S-shaped path 45 and a second reverse S-shaped path 47. An upper platen 52 is disposed between the S-shaped paths 45 and 47. The media follows along the first S-curve 45 and over the upper platen 52 followed by the second reverse S-curve 47 and into the simplex path 42 around to the lower platen 54. Since these paths are continuous and unidirectional, there is a decreased likelihood of a paper jam. In other words, when media feeds through the feedpath 40 the rollers of a specific nip do not change direction when a media sheet is disposed in that specific nip. Further, the S-curve design maximizes the volume of the ADF 30 by making multiple media bends therefore minimize the total footprint of the ADF 30.

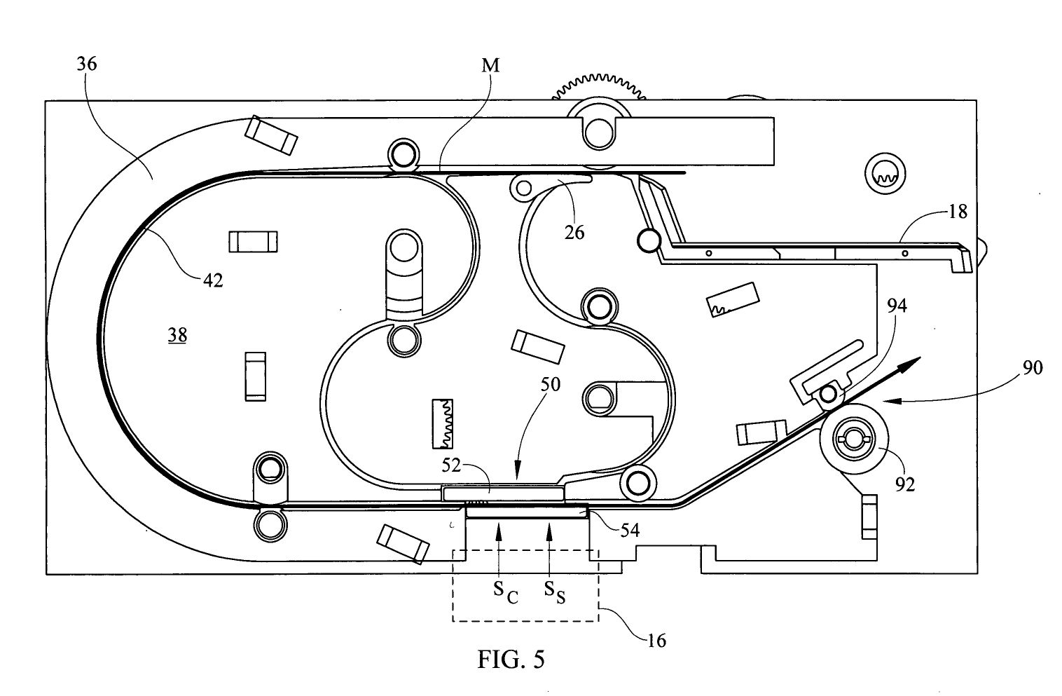

According to one exemplary embodiment, a gate 26 is actuatable for directing media either through a substantially C-shaped simplex path 42 to the simplex platen 54 or through a curvilinear duplex path 44 having a duplex platen 52 and including the simplex path 42 and the simplex platen 54. The gate or gating mechanism 26 is connected to a shaft generally extending between the side frames 32 which is selectively actuatable to move the gate 26 between a first position and a second position. The gate 26 is substantially curve shaped to direct media upward to the simplex path 42 or downward to the duplex path 44. Further, the gate 26 decreases scan time and media jams because the media is not unnecessarily directed through the duplex path 44 and duplex platen 52 when only simplex scan is needed. Therefore, the gate 26 allows simplex scan media to follow a much shorter media path and decrease scan cycle time as well as decrease media handling. Also, the gate 26 allows a duplex media to follow a unidirectional media path. Once a user selects between duplex and simplex mode at the control panel 11 or at a personal computer, mechanical means may be utilized to actuate the gate 26. For example, a clutching sequence by the motor may actuate the gate 26 between duplex or simplex modes. Alternatively, an electromechanical solenoid may be utilized to actuate the gate 26. As shown in FIG. 4, the gate 26 is disposed in an upper position which directs media from the input tray 18 into the duplex path 44. When the gate 26 is actuated to the second position, shown in broken line, the media M is blocked from entering the duplexing path 44 and is alternatively directed through the simplex path 42 (see also FIG. 5). The gate 26 may be formed of a low friction material to decrease paper jam potential and should be resistant to wear from paper moving through the system.

The upstream portion of the duplex path 44, comprises a duplex feed system 60 having a duplex feed roller 62 and upper and lower idler rollers 64, 66 spaced apart at about or less than 180° adjacent the peripheral surface of the feed roller 62. The duplex feed roller 62 is driven by the gear train 21 on the side frame 32 and motor (not shown). The spacing between the idler roller 64, 66 improves media handling through the curves in the duplex path 44 and thereby improve the scanning process and quality at the upper duplex platen 52. The idler rollers 64,66 each define a nip with the feed roller 62 which engages a leading edge of the media. Further the idler rollers 64,66 are biased by springs which provide some force for each nip. Such springs may include leaf springs, cantilever springs, compression or extension springs. As will be understood by one skilled in the art, the increased media bends in the S-curves 45,47 require additional media handling hardware to improve media feed reliability and scan quality. However, as previously indicated the curved path also results in a more efficient use of volume and smaller ADF footprint.

Along the second, reverse S-curve 47 of the duplex path 44 and at a junction with the simplex path 42, is a delivery system 70 which comprises a delivery feed roll 72 and opposed idlers 74, 76 located along a peripheral edge of the delivery feed roll 72. The delivery feed roll 72 is driven by the gear train 21 and a motor on the side frame 32. Like the duplex feed system 60, the delivery idler rolls 74, 76 are spaced apart about 180°. This defines a nip between the delivery feed roll 72 and each of the delivery idler rolls 74,76 which improve media handling through the upper portion of the duplex media path 44. The delivery feed roll 72 also engages media which is directed along the simplex path 42 only and directs the media to a feed system 80 by way of the simplex path 42. The idler rollers 74,76 are also mounted on cantilevered or leaf springs as previously described.

Downstream from the delivery system 70 is the feed system 80 which directs the media along the simplex path 42 and onto the lower simplex platen 54. The feed system 80 comprises a feed roller 82 and an opposed idler roller 84, mounted on a leaf spring. The delivery feed roller 82 is driven by the gear train 21 in order to direct media through the feedpath 40.

At the lower portion of the outer frame 36 and inner frame 38 is a scanning station or scanning area 50. The scanning station 50 comprises the upper platen 52, the lower platen 54 and the scan bar 16. The upper platen 52 is disposed along the duplex path 44 and the lower platen 54 is disposed along the simplex path 42. In this configuration, during duplex scanning the media passes over the duplex platen 52 and then moves to the simplex platen 54, while moving in a single continuous feed direction.

Although the upper and lower platens 52, 54 are substantially aligned, the upper platen 52 is slightly offset from the lower platen 54. The slight offset provides a more robust media feeding through the scanning area 50 and improved “hand-off” to the scanning area 50. Specifically, the media moving through the simplex path 42 transfers from the feedpath surface to engage the lower surface of the upper duplex platen 52. The duplex platen 52 is therefore offset to receive the media and inhibit catching of the media within the feedpath 42, thus promoting improved media feeding through the scanning area 50. According to the exemplary embodiment, the scan bar 16 is shown substantially vertically aligned with the upper and lower duplex platens 52,54.

As previously indicated, the scan bar 16 moves along a guide bar beneath the scan bed. Through such movement, the image sensor has at least two positions depicted by arrows S_{c} and Sₛ. The position depicted as S_{c} is a duplexing calibration position wherein the scan bar is calibrated for duplex scanning through the upper and lower scan platens 52,54. The second position, generally depicted as Sₛ is a scan position for both simplex and duplex scanning. A third position (not shown) is a simplex calibration position located near the flat bed scanning home position. The scan bar 16 moves along at least one guide bar between the various positions.

Upon passing through the scanning station 50 along the simplex path 42, media is directed along the media feedpath 40 to an exit system 90 which directs the media onto the auto-document feeder output tray 19 (FIG. 1). The exit system 90 comprises an exit roller 92 and an exit idler 94 opposite the roller 92. The exit roller 92 and idler 94 define a nip 95 which grips the media and directs it outwardly onto the output tray 19. As shown in FIGS. 2-3, the exemplary exit system 90 is driven by pulleys and a belt which are connected to the duplex feed roller 62.

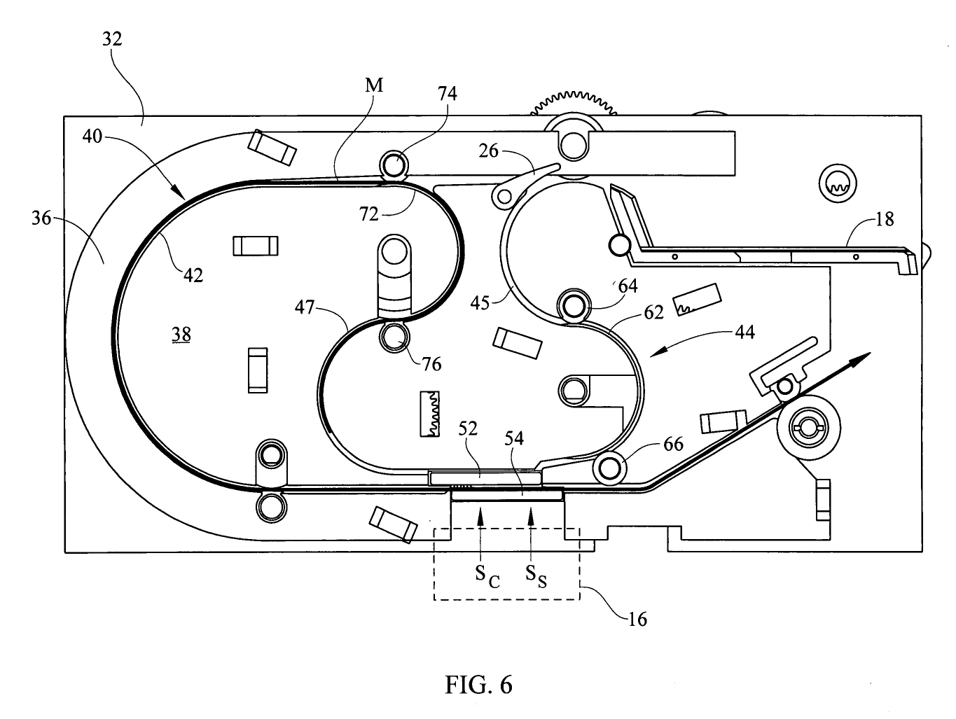

Referring now to FIGS. 5 and 6, the auto-document feeder 30 is depicted in two operating modes, simplex mode and duplex mode. FIG. 5 depicts a simplex scanning operation. Specifically, the scan bar 16 is calibrated at a simplex calibration position (not shown), but which is generally positioned closer to a flat bed scanning station. After calibration, a media sheet M is picked from the input tray 18 and put into the feedpath 40. The media M is depicted moving through the auto-document feeder 30 along the simplex path 42. The media M is picked from the input tray 18 and is moving along the substantially C-shaped simplex path 42. The gate 26 is actuated to a lower position so that the duplex path 44 is substantially blocked and the path to the simplex path 42 is revealed. The media M is moved through the simplex path 42 by the delivery feed roll 72 and idler roller 74 as well as the feed roller 82 and idler roller 84. The media M is directed between the outer frame 36 and inner frame 38 through the feedpath 40 until it reaches the scanning station 50. Within the scanning station 50 the media M passes between the upper duplex platen 52 and the lower simplex platen 54. The scan bar 16 is located beneath the scanning station 50 wherein the arrow Sₛ generally indicates the position of the image sensor for the simplex and duplex scans. As will be understood by one of ordinary skill in the art, the media M is stacked image (first) side up in the tray 18. As the media M passes through the simplex path 42, the text or image (first side) faces downward for scanning at the simplex platen 54. As the media M moves through the feedpath 40 the media is engaged by the exit system 90 including the exit roll 92 and idler roll 94. After moving through the exit system 90 the media M is stacked in collated fashion in the exit tray 19 (FIG. 1).

Referring now to FIG. 6, the duplex function of the duplexing ADF 30 is depicted. As previously indicated, the media M is stacked first side up in the tray 18. The gate 26 is actuated to an upper position wherein the simplex path 42 is blocked and the media M is first directed through the duplex path 44. As the media M is fed from the input tray 18 the media M reaches a nip defined by the idler 64 and the duplex feed roller 62. The media M is further directed around the duplex feed roller 62 to a nip defined by the feed roller 62 and idler roller 66. The upper duplex scanning platen 52 is located at a lowermost position of the duplex feedpath 44 between the first S-curve 45 and the second reverse S-curve 47. As the media M exits the first S-shaped path, the second side of the media is facing downward. In this disposition, the second side of media M faces the upper duplexing platen 52 before moving to a nip defined by the idler roller 76 and delivery feed roller 72. Next, the media sheet M moves around the delivery feed roller 72 and engages a nip between the delivery feed roller 72 and idler roller 74. The media M is then directed around the C-shaped portion of the simplex path 42 to the feed system 80 as previously described. As the media M advances, the media M passes between the upper duplex platen 52 and the lower simplex platen 54 where the first side of the media M is scanned. Accordingly, the media M passes first side down over the lower platen 54. As shown, the scan bar 16 is generally shown having a scan position Sₛ. Finally, the media 90 exits the ADF 30 by passing through the exit system 90 and onto the output tray 19. One of ordinary skill in the art should recognize the advantage of the instant device wherein the media does not move through feedpath portions where the media may engage itself while moving in opposite directions, as occurs with feedback paths used for duplex scanning.

The media feedpath 40 is sized so that the second side of media M is completely scanned at the upper platen 52 before the first side of the media M is scanned at the lower platen 54. Alternatively stated, the trailing edge of the media M must clear the upper platen 52 before the leading edge of the media M reaches the lower platen 54 for scanning so that the media second side data acquisition at the upper platen 52 is not inhibited by the media first side data acquisition at the lower platen 54. The length of the feedpath 40 is some preset length which is related to a maximum page length utilized in the auto-document feeder 30 wherein the maximum page length is less than the preset length. As the media M passes through the lower platen 54, the media M reaches the exit system 90 and is ejected onto the output tray 19. Accordingly, the apparatus allows for single pass duplex scanning wherein the media is not reversed in the feedpath, which often results in paper jams that must be cleared by a user for continued use of the auto-document feeder.

One further advantage of the instant auto-document feeder 30 is that the media M is returned to the output tray 19 without requiring an additional collating step. Prior art devices which reverse media sheets through a feedpath loop often require an additional loop or collation step in order to properly collate the media. To the contrary, the media in the present duplexing auto-document feeder is returned to the output tray 19 in a collated manner without the need for the extra collating step. This is due to the novel unidirectional duplexing feedpath of the present invention.

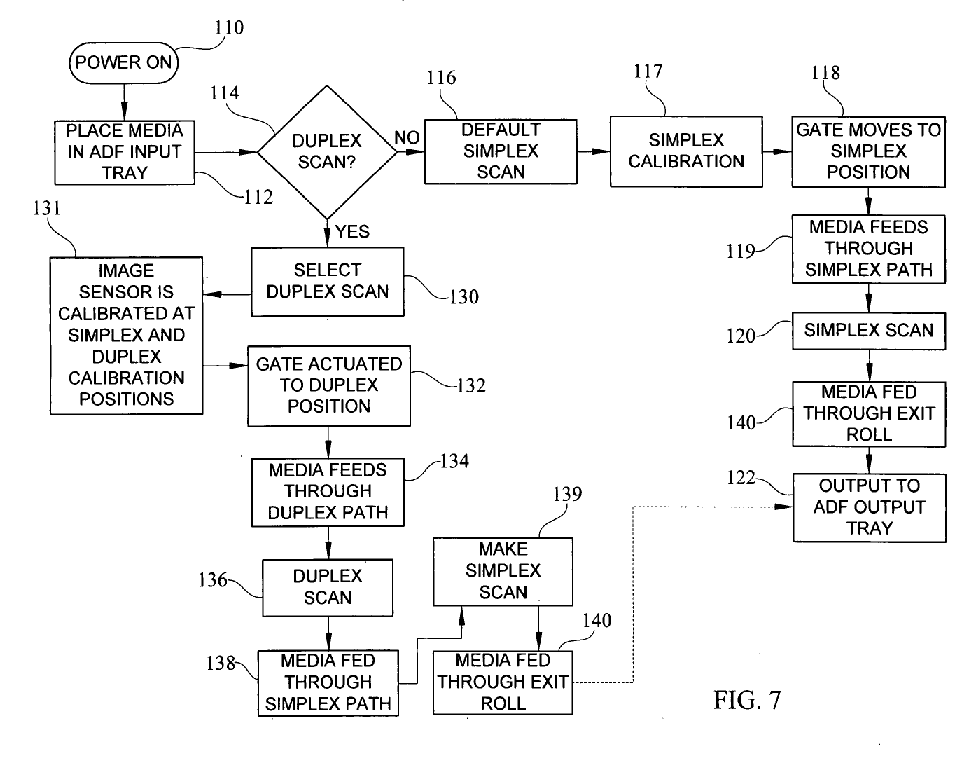

Referring now to FIG. 7, a flowchart for the method of use of the instant invention is shown. Initially the device is powered on at 110 and the target media is placed in the auto-document input tray 112. Next, the user selects whether the scan process will be a duplex scan or a simplex scan at 114. For example, the default selection is simplex unless a duplex selection is made by the user. The duplex selection may be made via software displayed on the computer monitor or display or alternatively the selection may be made at the control panel 11 of the device with the display and plurality of buttons located thereon. If the user selects a simplex scan 116 the gate 26 actuates to a lower simplex position wherein the path to the duplex feedpath 44 is blocked at 118. Further, the image sensor is calibrated at a simplex calibration position at 117. This may occur before or after the gate moves at 118. Next the media M is fed at 119 through the simplex path 42 and to the simplex scan at the lower platen 54 where simplex scan data is acquired at 120. Finally the media is directed at 122 to an exit system 90 before reaching the auto-document feeder output tray 19.

Alternatively, if the user selects the duplex scan at 130 the gate 26 actuates to an upper duplex position at 132 wherein the simplex path 42 is blocked and the media M must move to the duplex feedpath 44. Further, the image sensor is simplex and duplex calibrated at 131 by positioning the image sensor at the simplex calibration position (not shown) and position depicted as S_{c}. This may occur before or after the gate 26 is actuated at 132. Once the gate 26 is actuated to the duplex position, the media feeds at 134 through the duplex path and makes a duplex scan within the duplex path at 136. Next, the media continues to feed through the second half of the duplex path and into the simplex path at 138 where a simplex scan is made at 139. Finally, the media feeds through the exit roll at 140 and is output to the ADF output tray at 122.

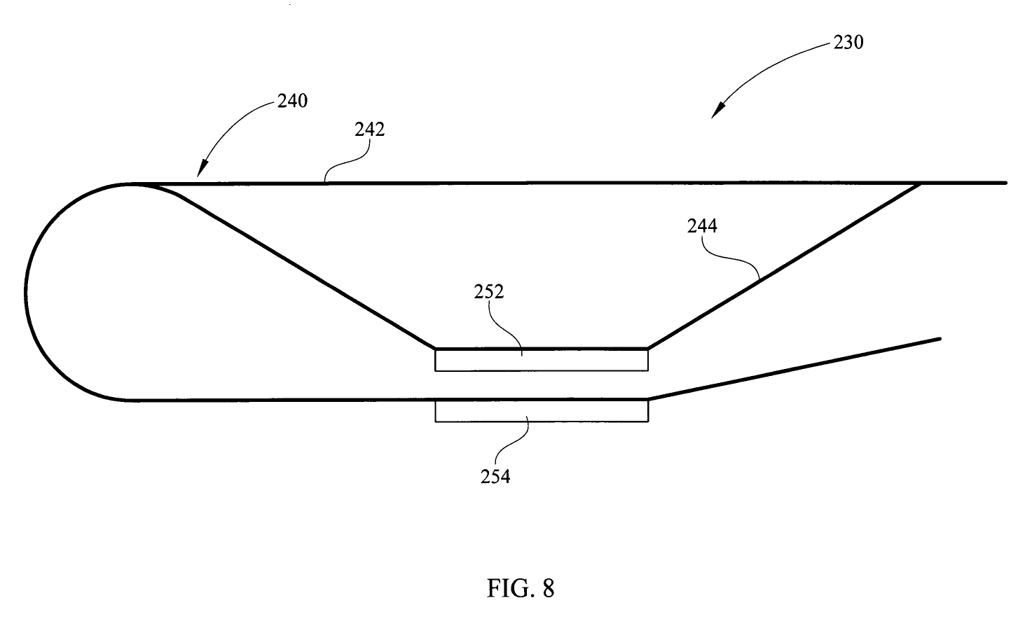

Referring now to FIG. 8, an alternative duplex ADF 230 is depicted. The feedpath 240 is shown having a simplex portion 242 and a duplexing portion 244. The simplex and duplex portions 242, 244 may be separated by a gate (not shown) as previously described in the first exemplary embodiment. The duplex portion 244 is defined by a substantially linear path rather than a curvilinear path, such as the S-shaped paths of the first exemplary embodiment. The angled duplexing path 244 eliminates a plurality of the rolls that are utilized throughout the S-shaped paths and therefore decreases manufacturing costs. However, the removal of the S-shaped paths requires that the media being duplex scanned be of a shorter length than the maximum media length for the first embodiment. This is because the alternative embodiment does not comprise the curved path which accommodates the length of the media. However, such length may be accommodated by increasing the size of the ADF duplexing scanner 230 and therefore increasing the length of the duplex path 244.

The duplexing path 244 comprises a duplexing platen 252 located at a lower portion of a path and aligned with a lower simplex platen 254. The duplex path 244 meets the simplex path 242 downstream of the duplexing platen 252 and moves around the substantially C-shaped simplex path to the lower simplex platen 254. After exiting the simplex path, the media exits the device to the output tray as previously described.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A duplexing auto-document feeder for an all-in-one device, comprising:
an input tray for stacking a plurality of sheets in feeding communication with a unidirectional feedpath;
said unidirectional feedpath including a simplex path and a duplex path;
an image sensor aligned with first and second platens along said unidirectional feedpath;
a gate disposed downstream of said input tray directing each of said plurality of sheets through one of said simplex or duplex scanning paths;
said simplex path passing one of said first and second platens;
said duplex path passing both of said first and second platens;
said image sensor acquiring one side of scan data through both of said first and second platens.

2. The duplexing auto-document feeder of claim 1, said gate being selectively engageable between a simplex position and a duplex position.

3. The duplexing auto-document feeder of claim 1, said simplex path being substantially C-shaped.

4. The duplexing auto-document feeder of claim 1, said duplexing path including at least one substantially S-shaped portion.

5. The duplexing auto-document feeder of claim 4, said duplexing path having a first S-shaped portion and a second reverse S-shaped portion.

6. The duplexing auto-document feeder of claim 1, said duplexing path being substantially enclosed by said simplex path.

7. The duplexing auto-document feeder of claim 1, said image sensor in optical communication with said upper and lower platens.

8. The duplexing auto-document feeder of claim 1, wherein said media passes one of said first and second platens before reaching the other of said first and second platens.

9. The duplexing auto-document feeder of claim 1, said unidirectional feedpath being a single pass continuous feedpath.

10. A duplexing auto-document feeder for a scanner, comprising:
an input tray in communication with a unidirectional feedpath;
said unidirectional feedpath having a simplex portion and a duplex portion;
a gate selectively actuatable to allow said input tray feeding communication with one of said simplex portion and said duplex portion;
an image sensor having a scanning position in optical communication with said unidirectional feedpath;
a simplex platen on said simplex path in optical communication with said image sensor;
a duplex platen on said duplex path in optical communication with said image sensor;
one of said simplex platen and said duplex platen disposed between said image sensor and the other of said simplex platen and said duplex platen.

11. The duplexing auto-document feeder of claim 10, said duplex portion having a curvilinear path.

12. The duplexing auto-document feeder of claim 11, said curvilinear duplex path defined by a first S-shaped path and a second reverse S-shaped path.

13. The duplexing auto-document feeder of claim 12, said duplexing platen disposed between said first S-shaped path and said second reverse S-shaped path.

14. The duplexing auto-document feeder of claim 10. said simplex portion partially surrounding said duplex portion.

15. The duplexing auto-document feeder of claim 10, said duplex path being a substantially linear path.

16. The duplexing auto-document feeder of claim 15, said substantially linear path being defined by a plurality of angled linear paths.

17. A duplexing auto-document feeder for a scanner, comprising:
an auto-document feeder having a single pass feedpath;
a gate located along said single pass feedpath selectively engageable between a first simplex position and a second duplex position;
a simplex platen and a duplex platen aligned between an image sensor and said single pass feedpath;
each of said simplex and duplex platens in optical communication with said image sensor;
said feedpath having a length between said first platen and said second platen greater than a media length.

18. The duplexing auto-document feeder of claim 17, said simplex platen and said duplex platen at least being partially aligned with an image sensor.

19. A method of duplex scanning, comprising:
selecting one of a simplex or duplex scan;
activating a gate corresponding to said selecting of said simplex or duplex path;
calibrating an image sensor based on said selecting of said simplex and duplex path;
directing medium in a single direction from an input tray through either a duplex feedpath or a simplex scan having shared path portion with said duplex path;
moving said medium to a first platen and a second platen when said duplex feedpath is selected, said first and second platens in optical communication with an image sensor;
moving said medium over one of said first platen and said second platen when said simplex feedpath is selected.

20. A duplex scanning auto-document feeder, comprising:
a unidirectional feedpath having a simplex path and a duplex path;
a first platen and a second platen disposed along said feedpath;
said first and second platens aligned between an image sensor scan position and each of said simplex path and said duplex path, respectively;
said image sensor having at least one position in optical communication with said first platen, said second platen, said simplex path and said duplex path.
